(19) United States
(12) Patent Application Publication
(10) Pub. No.: US 2015/0199636 A1
(43) Pub. Date: Jul. 16, 2015

(54) METHOD AND SYSTEM FOR PERFORMANCE METRIC ANOMALY DETECTION IN TRANSPORTATION SYSTEMS

(71) Applicant: Xerox Corporation, Norwalk, CT (US)

(72) Inventors: Alvaro E. Gil, Rochester, NY (US); John C. Handley, Fairport, NY (US)

(73) Assignee: Xerox Corporation, Norwalk, CT (US)

(21) Appl. No.: 14/153,305

(22) Filed: Jan. 13, 2014

(51) Int. Cl. G06Q 10/06; G06Q 50/30

(52) U.S. Cl. CPC G06Q 10/06393; G06Q 50/30

(57) ABSTRACT

A transportation service data assessment system includes a data set holding f performance metrics for various route components of a transportation service. When the system receives a selected set of operational data parameter labels, as well one or more route components, it develops a matrix of performance metrics corresponding to the operational data and route components, determines a distance between each row of the performance metric matrix to yield a multi-dimensional matrix, and maps the distance data to a 2-D or 3-D coordinate set so that to yield a coordinate matrix. The system groups the data of the third matrix into clusters and presents the clusters on a display so that outliers are visually distinguished from clustered items, and so that redundant items are also visually apparent in the clusters.

### BACKGROUND

Transit agencies and other transportation service providers frequently face the problem of having a massive amount of performance data that awaits analysis in order to determine what is working and what is not working. It is very expensive to use human experts to perform this analysis. Further, when this is carried out by humans, the results may be too late to act upon, since the opportunities to implement changes at the right time may no longer be available by the time the human analyzes the data.

Transit agencies also generate a significant amount of performance metrics that can be redundant. Eliminating redundant information may help reduce costs associated with redundant data monitoring systems. Thus, transportation service providers can benefit from improved ways to help identify performance metrics.

### SUMMARY

In an embodiment, a processor (which may be one or more processors) implements a method of assessing a transportation service monitoring system by accessing a data set comprising performance metrics for each of a number of route components of a transportation service; receiving a selected set of operational data parameter labels; and retrieving from the data set, for each of a selected set of route components, the performance metrics that correspond to the labels. The processor constructs a two-dimensional N×M first matrix P of the performance metrics so that one dimension of the first matrix is a performance metric and each other dimension of the first matrix is a parameter value for a route component with which the performance metric is associated. The processor determines a distance between each row of the first matrix P and using the distance to construct a second matrix D; maps the second matrix D to a coordinate set to yield a third matrix C; groups data elements of third matrix C into clusters; and presents the clusters on a display so that data elements that are outliers are visually distinguished from data elements that are clustered.

Optionally, presenting the clusters on the display will also visually identify clustered data elements that represent redundant information. Optionally, presenting the clusters on a display so that outlier data elements are visually distinguished from clustered data elements may include spatially separating the outlier data elements from the clustered data elements. Presenting the clusters on a display so that outliers are visually distinguished from clustered items may include, for any data element that is clustered with the group in a displayed two dimensions but an outlier with respect to a third dimension, highlighting the data element in a color that is different from that of the other grouped data elements.

Before mapping the second matrix D to the third matrix C, the system may detect and optionally eliminate one or more of the extreme outliers from the data elements. To detect the extreme outliers, the processor applies robust principal component analysis to the second matrix D or to a function of the second matrix D. Applying the robust principal component analysis may be done to the function of the second matrix D, and if so the processor may generate the function of the second matrix D by constructing a matrix J=I_{N×N}−(1, N)*1^{T}*1 where I is the identity matrix, N is the number of rows of first matrix P, and each 1 is a vector containing one row and N columns of ones. The system may determine D² as a square of every element in second matrix D; construct a matrix B=−0.5*J*D²*J; and use matrix B as the function of D to which the robust principal component analysis is applied. Before constructing the second matrix D, the system may construct a transpose M×N matrix P^{T} of matrix P and use the transpose matrix P^{T} in place of first matrix P when determining the distance between each row of the first matrix.

Optionally, the system may identify redundant data elements and non-redundant data elements from the data elements of third matrix C. If so, it may construct a transpose M×N2 matrix P^{T}, where N2 includes only the identified non-redundant data elements and none of the identified redundant data elements. The system may then determine a distance between each row of the transpose matrix P^{T}, and it may use the determined distance between each row of the transpose matrix P^{T} to construct an updated second matrix D₂. The system may then map the updated second matrix D₂ to a coordinate set to yield an updated third matrix C₂, group data elements of matrix C₂ into clusters, and present the clusters of matrix C₂ on the display so that data elements that are outliers are visually distinguished from data elements that are clustered.

In another embodiment, a transportation service performance assessment system includes a data set comprising performance metrics for each of a number of route components of a transportation service, a display, a processor (which may be one or more processors) and a computer-readable medium containing programming instructions that, when executed, instruct the processor to implement a method such as that described above. For example, the system may receive a selected set of operational data parameter labels; retrieve from the data set, for each of a selected set of route components, the performance metrics that correspond to the labels; construct a two-dimensional performance metric matrix using the retrieved performance metrics and parameter values; use values of the two-dimensional performance metric matrix to construct a higher-dimensional matrix; detect extreme outliers from data in the higher-dimensional matrix using robust principal component analysis; map the higher-dimensional matrix data to a coordinate matrix; group data elements of the coordinate matrix into clusters; and cause the clusters to be output on the display so that data elements that are outliers are visually distinguished from data elements that are clustered, and so that extreme outliers are distinguished from both the clustered data elements and the non-extreme outliers.

Optionally, the instructions that cause the clusters to be output on the display may include instructions to visually distinguish clustered data elements that represent redundant information. The instructions to present the clusters on the display so that outlier data elements are visually distinguished from clustered data elements may include instructions to spatially separate the outlier data elements from the clustered data elements. The instructions to present the clusters on a display so that outliers are visually distinguished from clustered items may include instructions to, for any data element that is clustered with the group in a displayed two dimensions but an outlier with respect to a third dimension, highlight the data element in a color that is different from that of the other grouped data elements.

Optionally, the system may include additional instructions that, when executed, instruct the processor to, before mapping the higher-dimensional matrix to the coordinate matrix, apply robust principal component analysis to the higher-dimensional matrix or to a function of the higher-dimensional matrix. The instructions to apply the robust principal component analysis may include instructions to do so to the function of the higher-dimensional matrix. Before constructing the higher-dimensional matrix, the system may construct a transpose M×N matrix P^{T} of the two-dimensional performance metric matrix and using the transpose matrix P^{T} to determine the distance between each row of the two-dimensional performance metric matrix when constructing the higher-dimensional matrix.

In the alternate embodiment, the system also may optionally identify redundant data elements and non-redundant data elements from the data elements of the coordinate matrix. If so, it may construct a transpose matrix P^{T}, that includes only the identified non-redundant data elements and none of the identified redundant data elements. The system may then determine a distance between each row of the transpose matrix P^{T}, and it may use the determined distance between each row of the transpose matrix P^{T} to construct an updated higher-dimensional matrix. The system may then map the updated higher-dimensional matrix to a coordinate set to yield an updated coordinate matrix, group data elements of the updated coordinate matrix into clusters, and when presenting the clusters on the display, using the clusters of the updated coordinate matrix.

### BRIEF DESCRIPTION OF THE DRAWINGS

FIG. 1 is a flowchart that illustrates various steps of a method of analyzing and presenting transit service data.

FIG. 2 illustrates an example of a performance metric matrix.

FIG. 3 illustrates an example of a process of eliminating extreme outliers in a transit service data set.

FIG. 4 illustrates an example of visually represented data after extreme outliers have been eliminated.

FIG. 5 is an alternate visual representation of the data of FIG. 4, in which outliers are illustrated.

FIG. 6 illustrates an example of a data plot using the two largest eigenvalues in a data set.

FIG. 7 illustrates a visual representation of data for an example set of routes.

FIG. 8 is an example of a dashboard that illustrates the data of FIG. 7 in a map format, with outliers visually distinguished by color and/or line thickness.

FIG. 9 is a block diagram showing elements of computing systems that may be used to implement various embodiments described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

As used in this document, the terms “transportation service” and “transit service,” as well as transportation or transit systems, interchangeably refer to an entity that owns, operates or manages a fleet of vehicles that travel various routes according to determined schedules. Examples of transit services include public bus services, rail transit systems, airlines, air traffic control agencies, and similar systems.

This document refers to a “route component” as a scheduled operational component of one or more routes of a transit service. Examples of route components include stops (such as bus or train stops), segments of routes (such as a first leg of an airplane's itinerary, or a sequence of scheduled bus stops along a bus route), a particular vehicle (e.g., bus, plane or train) or a specific human vehicle operator (e.g., driver or pilot), or a complete route including all stops from a first point A to a second point B.

When this document uses the term “operational data” with respect to a route component, it refers to one or more measurable parameters of the route component. Examples of categories of operational data include ridership data for a route (such as a number of passengers who travel the route), a capacity usage measurement (such as the percent of the capacity of a particular vehicle is being used), a measure of the number of riders waiting at a particular stop, revenue per distance element (such as dollars per mile), amount of delay, vehicle or driver performance criteria (such as whether the vehicle/driver follows speed, acceleration or deceleration requirements), headway regularity (i.e., the time between vehicles at a particular stop) and other metrics.

When this document uses the term “outlier” in the context of a data set, it refers to an element of the data set having a value that differs from a majority of other elements in the data set by at least a threshold. When visually presented in a two-dimensional or three-dimensional plot, the majority data elements will appear to the observer as grouped together, while outliers will visually appear as separated from the group by space, color, or other indicia. An “extreme outlier” refers to an outlier having a value that differs from a majority of other elements in the data set by at least a second threshold, where the second threshold is greater than the threshold used to distinguish non-extreme outliers. Extreme outliers often may be the result of either a measurement error or a data set that has a heavy-tailed distribution.

The present disclosure is directed to a method and system for analyzing data from a transit system in a way that can help the system operator eliminate redundancy and/or improve efficiency in scheduled routes. For example, public transportation companies monitor quality of service analytics related to how a transit system is performing. Generally, the analytics reflect average performance of the transit system, variation of the performance over time, and a general distribution of performance over time. For a public transportation system, low quality of service can result in decreased ridership, higher costs and imbalanced passenger loads. As performance variability increases, waiting times also increase, thereby directly impacting customer satisfaction. From a passenger perspective, reliable service requires origination and destination points that are easily accessible, predictable arrival times at a transit stop, short running times on a transit vehicle, and low variability of running time. Poor quality of service can arise from inefficiencies inherent in the system, and it can prompt passengers to choose another transportation option, thereby reducing the public transportation company's income.

This document describes methods and systems that execute a performance metrics analysis to automatically identify what metrics are either alike or different. The analysis can be carried out to map high dimensional data into a lower dimension so that the results can be visually inspected by humans. The low-dimensional mapping indicates what transportation service routes and/or stops are similar or different in a graphic format using map coordinates. The system may also help analyze low dimensional data that cannot be shown in a plot (e.g., data having dimensions greater than three), since the system uses algorithms that cluster data that is representative of similar performance metrics. The system also may help the transportation service provider detect performance metrics that are redundant, or implement new performance metrics that report information that is not currently available to the service provider.

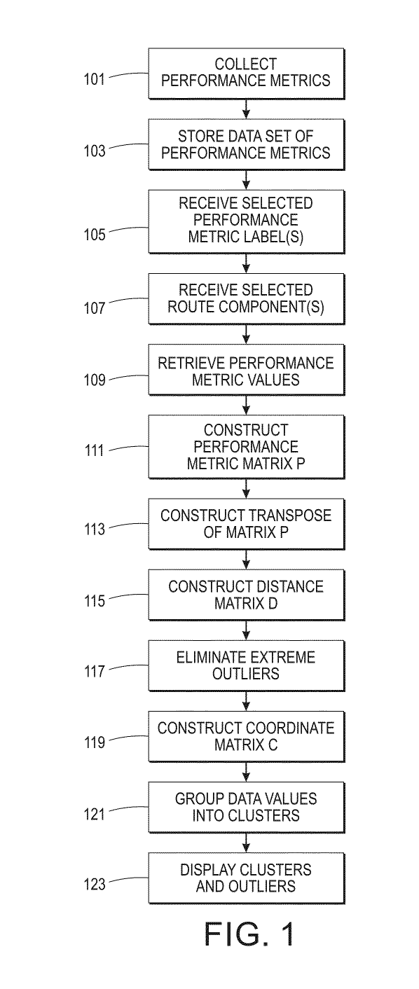

FIG. 1 is a flowchart illustrating a method that a transportation service monitoring system may use to help system planners identify and act upon redundant information and/or outliers. The system may collect various performance metrics (step 101) for various route components of the transportation service using any suitable means. For example, the system may automatically receive monitored data from onboard data collection systems from one or more transit vehicles, or from sensors installed at vehicle stops or other positions along a transit system route. The system may receive the data via wired or wireless data transmission, by batch data upload or transfer, or by any other suitable means. The system may maintain historic data in a data storage facility, and it may optionally periodically request and/or receive updates based on monitored information.

The system will store the collected performance metrics in a data set (step 103) as a database or table structure that associates each metric with the route component(s) for which the metric provides a unit of measure. For example, performance metrics for a route component that is a bus stop may include frequency of vehicles per hour, percent person-minutes served, on-time performance, or headway regularity. Any of these metrics also may be associated with one or more additional route components. For example, a measurement of on-time performance may be associated with a driver, a vehicle, one or more stops, one or more route segment, or an entire route. The metrics also may be associated with one or more spatial or temporal parameter values, such as a unit of time or distance.

The system will receive a selected set of one or more performance metric labels (step 105). Each performance metric label will be a name, title or other descriptive indicator of a performance metric for which operational data is available. The system may receive the selection of performance metric labels via a user-selected input from a user interface, from a remote command, or based on one or more computer-implemented instructions, such as instructions that require automatic analysis at predetermined intervals or upon the occurrence of certain conditions. The system will also receive a selected set of one or more route components (step 107). The system will then access the data set and retrieve, for each of the selected set of route components, performance metric values for the selected route components (step 109).

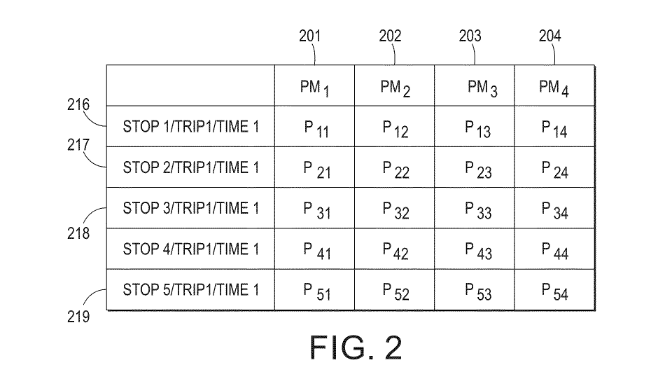

The system will use the retrieved performance values to construct a set of data matrices. First, the system will construct a two-dimensional N×M first matrix P of the performance metrics (step 111). In the performance metric matrix P, each row is a performance metric and each column is a parameter value for a route component with which the performance metric is associated. An example of this is shown in FIG. 2, which illustrates a transpose P^{T} of a matrix P that includes four performance metrics 201-204 for five route components 216-219. The four performance metrics 201-204 shown in this example are frequency of vehicles per hour PM₁, percent person-minutes served PM₂, on-time performance PM₃, and headway regularity PM₄. The route components 216-219 are five bus stops in a particular route (trip) at a certain time. (As an alternative example, one could construct a matrix using parameter measurements received from a single bus stop at five or more different times, or from multiple bus stops on multiple routes, or at a single bus stop location that is a part of multiple bus routes.) The values are shown in the transpose matrix are in the format Pᵢⱼ, where i represents the i^{th} row and j represents the j^{th} column of the transpose matrix.

Returning to FIG. 1, the system then determines a distance between each row of the first matrix P and uses the determined information to construct a second matrix D of distance values (step 115). The system may do this using any suitable means, such as by determining Euclidean distances, for example, when N=M=5 and using the norms of each value to derive a matrix such as:

$$D = [ \begin{matrix}{d}_{11} & … & {d}_{15} \\ ⋮ & ⋱ & ⋮ \\ {d}_{51} & … & {d}_{55}\end{matrix} ]$$

in which the diagonal entries would each be zeroes, and each dᵢⱼ equals its corresponding dⱼᵢ. As an example, the system may determine d₁₅ using a formula such as:

$${d}_{15} = \sqrt{\begin{matrix}{( {P}_{11} - {P}_{51} )}^{2} + {( {P}_{12} - {P}_{52} )}^{2} + {( {P}_{13} - {P}_{53} )}^{2} + \\ {( {P}_{14} - {P}_{54} )}^{2} + {( {P}_{15} - {P}_{55} )}^{2}\end{matrix}}$$

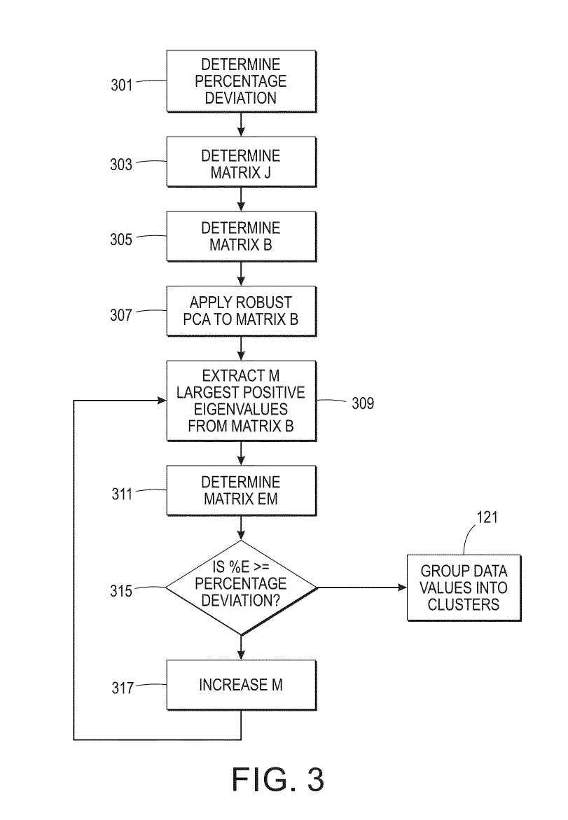

Optionally, the system may apply optimization to determine the type of norm to use when constructing the second matrix D. One option is to minₚ Eₘ, where p is the value of the p-norm. Here, Eₘ would be an error reconstruction, as described below in the discussion of FIG. 3. Another example of optimization would be to min_{[e,m}] Eₘ such that mₒ<=m<=m₁, where mₒ and m₁ are distinct largest positive eigenvalues of a matrix B (also described in the context of FIG. 3 below) and m is an integer value.

The system may then map the second matrix D to a lower-dimensional coordinate set to yield a third matrix C of coordinate values (step 119). The lower-dimensional mapping will take a multi-dimensional data set and reduce it to a set of two-dimensional or three-dimensional values so that the data set can be visually perceived when presented on a display. Using the example of FIG. 2 above, the data set includes five dimensions corresponding to five stops. This may be mapped to a two-dimensional coordinate space in a matrix C of the form:

$$C = [ \begin{matrix}{x}_{1} & {y}_{1} \\ {x}_{2} & {y}_{2} \\ {x}_{3} & {y}_{3} \\ {x}_{4} & {y}_{4} \\ {x}_{5} & {y}_{5}\end{matrix} ]$$

in which each pair (xᵢ, yᵢ) contains the coordinates of the i^{th} bus stop index in the 2-D plane. Additional steps that may be followed in the construction of the coordinate matrix C will be discussed below.

The system will then group the data of third matrix C into clusters (step 121), and it will generate a visual representation of the clusters and outliers on a printed substrate or electronic display medium in a two-dimensional or three dimensional format so that outliers are visually distinguished from clustered items (step 123). Extreme outliers may be further distinguished from non-extreme outliers. For example, they may not be displayed at all if their values are beyond the scale of the display.

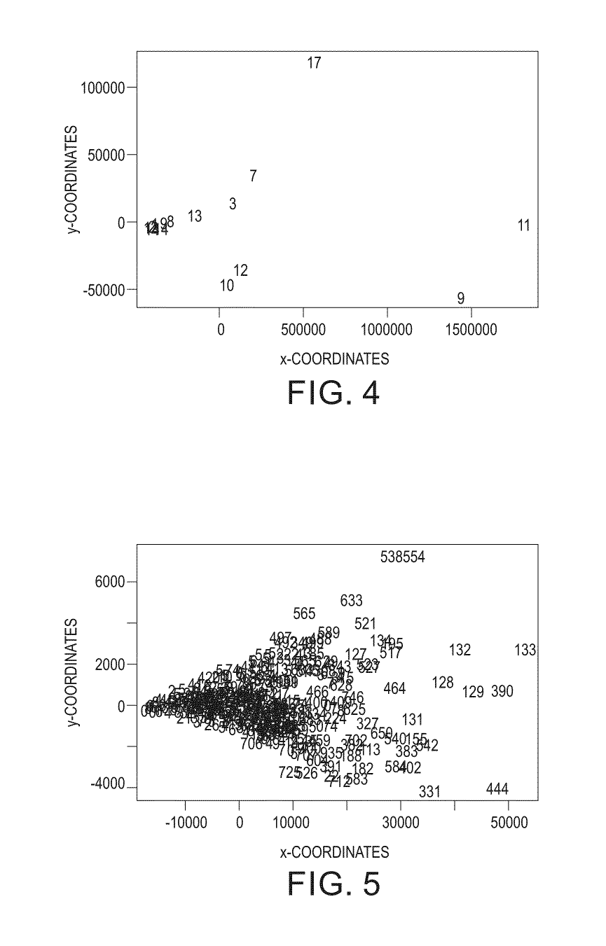

The visual representation of the clusters may be useful to a human to identify redundant values that are monitored by the system. For example, data points that are tightly clustered may evidence redundant information, and the transportation system operator could use that knowledge to eliminate one or more data monitoring stations and/or reduce the frequency of one or more monitored parameters, thus reducing the costs associated with those items. This will be described in more detail in the example of FIG. 4 below.

In another embodiment, referring back to FIG. 1, before calculating the distances to determine the distance matrix D, the system may determine a transpose M×N matrix P^{T} (step 113), or it may simply calculate the first matrix P in the transpose M×N format in the first place (instead of N×M format). In other words, the system may implement either of steps 111 and 113, or both of steps 111 and 113, in any order. The resulting coordinate matrix C can be used to generate a visual representation of outliers, which a transportation system service provider may use to identify operational aspects of the transit service that may require maintenance, modification or other attention. An example of this embodiment will be described in more detail in the example of FIG. 5 below.

When determining the coordinate matrix C, the system may use various methods to reduce the higher dimensional data to a lower dimensional (2-D or 3-D) coordinate matrix. In some embodiments, the system may employ methods that detect, and optionally remove or de-emphasize, extreme outliers from the data (step 117). This will help identify and/or eliminate values whose deviations from the grouping are caused by monitoring error or other unusual circumstances, rather than by true system issues that may need to be addressed. An example of an extreme outlier elimination process is illustrated in FIG. 3, wherein after determining the distance matrix D, the system may define the percentage deviation of the error reconstruction, % Eₜ, tolerated when the original data is mapped to a low-dimensional space (step 301). One algorithm that may be used for error reconstruction in the low-dimensional space is Eₘ=max (abs(D−Dₘ)) where Dₘ is the distance matrix of the low-dimension coordinates. The system may then construct a matrix J=I_{N×N}−(1, N)*1^{T}*1 where I is the identity matrix, N is the number of rows of P, and each 1 is a vector containing one row and N columns of ones (step 303).

The system may then compute the matrix B=−0.5*J*D²*J where D² denotes taking the square of every element in D (step 305). The system may apply robust principal component analysis (PCA) to the matrix B since to remove extreme outliers from the data set (step 307), thus enabling the system to provide more accurate and/or robust visual representations of grouped data. In contrast to classical PCA, robust PCA methods obtain principal components of a data set that are not influenced much by outliers. Examples of robust PCA methods are disclosed in Hubert et al., “ROBPCA: A New Approach to Robust Principal Component Analysis,” Technometrics, vol. 47, issue 1 (2005).

Then, the system may extract the m largest positive eigenvalues σ₁, . . . , σₘ of matrix B and their corresponding m eigenvectors e₁, . . . , eₘ (step 309). The system may form a matrix Eₘ (step 311) using the eigenvectors and the diagonal matrix Vₘ^{1/2} with the square of the m eigenvalues obtained in the previous step. Then, to determine the low-dimensional coordinates matrix C (step 119 of FIG. 1), the system may compute C=Eₘ*Vₘ^{1/2}.

Optionally, before performing the clustering (step 121 of FIG. 1) of the data in coordinate matrix C, the system may compute a low-dimensional distance matrix Dₘ of coordinate matrix C, and also determine the percentage deviation of the error reconstruction % E=(Eₘ−E_{H})/E_{H}. E_{H}, which represents error reconstruction in the high-dimensional space, may be determined by the following formula:

max(abs(D−D_{H})),

where D_{H} is the distance matrix of Eₚ*Vₚ^{1/2}. Eₚ contains all the eigenvectors obtained in the robust PCA application having positive eigenvalues. If % E is less than or equal to % Eₜ (step 315) then the system may apply a clustering algorithm. If not, then the system may increase the value of m (step 317) and repeat the process of FIG. 3 starting with step 309 (extracting the m largest positive eigenvalues) until % E is less than or equal to % Eₜ. Then, when performing the clustering (step 121 of FIG. 1), the system may use any suitable clustering process, such as k-means clustering.

As an additional option, the system may eliminate redundant metrics when presenting its final output. As one way of doing this, after the system presents its metrics N in coordinate matrix C, it may determine that the metrics include N1 redundant metrics and N2 non-redundant metrics. The system may identify the N1 and N2 metrics automatically (as described below) based on comparison of metric values and determining which metrics have similar values, it may receive a manual identification of redundant and/or non-redundant metrics based on the presentation of matrix C data to a user, or it may use a combination of the two techniques such as automated classification followed by manual refinement of the results of the automated classification.

After determining the N2 non-redundant metrics, the system may construct a transpose M×N2 matrix P^{T} using only the metrics that were determined to be non-redundant. It may then use the distances between the rows of matrix P^{T} using the norm (p-norm) to create a higher-dimensional distance matrix D₂. While matrix D₂ will be of a lower dimension than D because of the elimination of redundant data, matrix D₂ will be of a higher dimension than matrix P^{T}. Then, the system may determine a second coordinate matrix C₂ using the matrix D₂ and mapping methods such as those described above. The system can then present the clustered data of the second coordinate matrix C₂ so that outliers are visually distinguished from clustered data elements, without the need to display redundant values.

As an example, referring to the visual representation of data in FIG. 4, the illustration is a plot of data for a bus network over a period of 14 months. The data represents nineteen performance metrics (i.e., N=19), including mean of travel time, travel time variability (standard deviation), mean and standard deviation of ridership, mean and standard deviation of service over revenue miles, mean and standard deviation of productivity, mean and standard deviation of passenger miles, mean and standard deviation of mobility index, mean and standard deviation of number of standees, travel time reliability, mean and standard deviation of volume to capacity ratio, and mean and standard deviation of service effectiveness. The route components are complete routes. Any mean or standard deviation is computed across all the metrics associated with a particular route within a month. The operational data available for these metrics are M=727 values. The system uses the Euclidean distance to compute the matrix D and derive the matrix B. The system applies robust PCA to the matrix B and extracts the two largest eigenvalues. FIG. 4 shows a 2-D mapping of the performance metrics. Each numeric value represents a performance metric label for example, the metrics here are mean of travel time (index 1) and a number of other metrics that are closely grouped and thus not easily distinguished, mean of ridership (index 3), mean of productivity (index 7), mean and standard deviation of passenger miles (indices 9 & 10), mean and standard deviation of mobility index (indices 11 & 12), mean of number of standees (index 13), mean and standard deviation of passenger miles (indices 9 & 10), and mean of service effectiveness (index 17). The numbers that cannot be distinguished in FIG. 4 indicate that their distances are so close in their original space that one may view them as providing redundant information. Indices 11 and 17 are clearly outliers since they are far apart from each other and from the rest of the group. Indices 3, 7, 12, and 10, and possibly also index 13, also may be considered outliers depending on the thresholds used for determining when a data point is an outlier from a group. Thus, we see that we can preserve the nine non-redundant metric indices 1 (although it could be any number located on top of each other at the left side of the FIG. 4), 3, 7, 9, 10, 11, 12, 13, and 17, and eliminate the redundant metric indices.

Optionally, multidimensional aspects of the data may be represented in a two-dimensional plot by presenting the numbers in FIG. 4 in different colors. For example, the grouped numbers may be presented in black, while one or two of the grouped indices may be presented in a different color (such as red) if they significantly differ in only one parameter value from other indices while remaining similar to the other indices for other parameter values.

Next, the system may form a transpose matrix P^{T} with N2=9 (the nine non-redundant indices previously selected) columns and M=727 rows and derive the 2-D coordinates for this case. FIG. 5 shows an example of how the routes' performance metrics may be shown on a 2-D map. One may interpret this plot as reading a map where numbers close to each other correspond to routes with similar performance metrics. These data points also may be illustrated in different colors, with one color representing a homogeneous group close to the projection space that may be considered “regular observations,” a second color representing points which lie close to the projection space but far from the regular observations, a third color representing points which have a large orthogonal distance to the projection space but are within the regular observations (referred to as “orthogonal outliers”), and a fourth color representing points which have a large orthogonal distance and are located on the projection space far from the regular observations. The system could cluster the routes based on these four point types since they would tend to have similar metric values and use these clusters to report the findings. Also, the system can further apply another clustering algorithm to these four clusters. For instance, the system could apply k-means clustering to subdivide each of the four clusters into another number of clusters.

Note that in the context of FIG. 5, the error reconstruction difference when it uses the matrix P^{T} with N=19 and N2=9 is only 2.3%, which supports the fact that the discarded metrics provide redundant information.

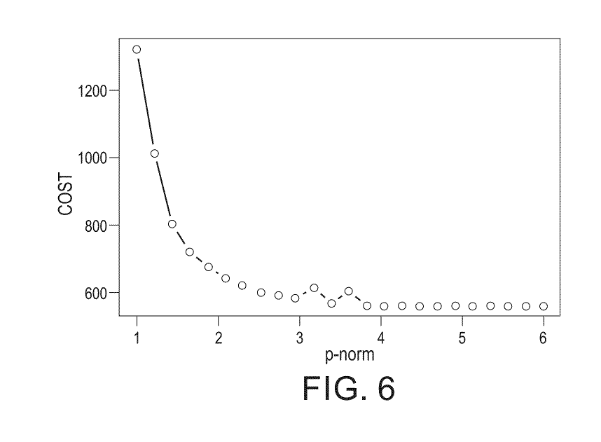

The error reconstruction E_{L}=max (abs(D−Dₘ)) also can be optimized by selecting a suitable p-norm to compute the distance matrix D. The system may create p=24 equidistant values between 1 and 6 and compute the p-norm using these p values and further compute Eₘ for each case. FIG. 6 shows the results of an example that always uses the two largest eigenvalues of the matrix B. It can be seen that the optimal reconstruction error (cost objective) in this example lies around the value p=4.48. Any non-gradient optimization technique could be used to determine the optimal p value.

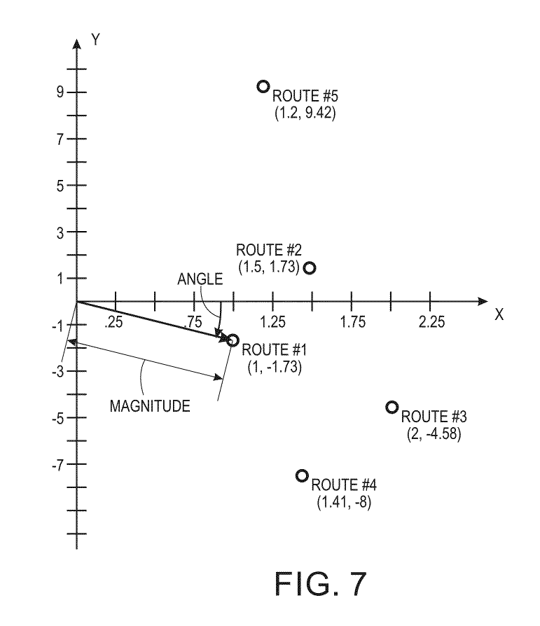

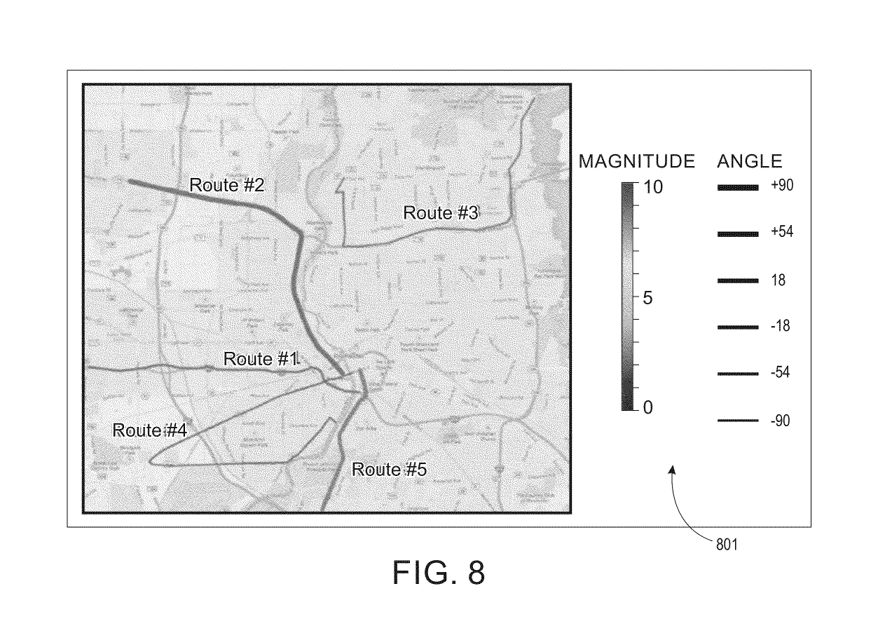

The system may include a user interface that presents the data to a user in various configurations that help the user identify clusters and outliers obtained in FIG. 5. For example, referring to FIG. 7, data associated with five different routes or stops can be illustrated in a two-dimensional format. The two-dimensional mapping described above can yield the plot of FIG. 7. In the plot, routes having larger angles or lengths may be considered to be outliers, while those hacking shorter angles and/or length may be considered typical or clustered. The data can then be represented on a dashboard such as that shown in FIG. 8, in which the angle for each route can be represented by line thickness. This means that, for each route shown in FIG. 8, a thicker line corresponds to a larger positive angle whereas a thinner line corresponds to a smaller negative angle. The magnitude (length) of each line in FIG. 7 can be visually represented by a number of colors in FIG. 8, so that one color (such as red) represents a longer line in FIG. 7 (i.e., an outlier) while a different color (such as blue) represents a shorter line in FIG. 7. The dashboard may include a key 801 showing what the possible variations in colors and line thicknesses mean.

The system's presentation of clusters and outliers can be used in several ways to help transportation system planners make decisions about system operations. For example, if the observations are routes (the P matrix case), the system could identify and automatically highlight extreme outliers for inspection. The planner can then determine whether the outlier represents an exceptionally bad or unusually good operation, and then analyze the operational parameters of that route to either (i) troubleshoot the route and/or avoid those parameters if the outlier is bad, or (ii) emulate the parameters or establish them as a benchmark if the outlier is good.

In the case of when the observations are performance metrics (P-transpose matrix case), one could identify extreme outliers as performance metrics to reserve as key productivity indicators, as well as performance metrics that provide unique and important information about system performance. System planners could also identify clusters from which one could select a medoid representative to capture the essential aspect of the metrics in that cluster, the rest being redundant.

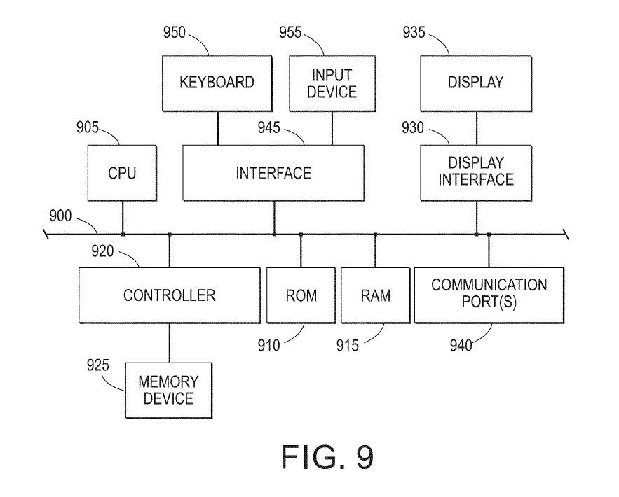

FIG. 9 depicts an example of internal hardware that may be used to contain or implement the various computer processes and systems as discussed above. An electrical bus 900 serves as an information highway interconnecting the other illustrated components of the hardware. CPU 905 is a central processing unit of the system, performing calculations and logic operations required to execute a program. CPU 905, alone or in conjunction with one or more of the other elements disclosed in FIG. 9, is a processing device, computing device or processor as such terms are used within this disclosure. When this disclosure or any claim uses the term “processor,” unless specifically stated otherwise it may include a single processor, or multiple processors that distributed within a system or among multiple systems in a way such a together they perform all steps of a defined method. Read only memory (ROM) 910 and random access memory (RAM) 915 constitute examples of memory devices.

A controller 920 interfaces with one or more optional memory devices 925 that service as data storage facilities to the system bus 900. These memory devices 925 may include, for example, an external DVD drive or CD ROM drive, a hard drive, flash memory, a USB drive or another type of device that serves as a data storage facility. As indicated previously, these various drives and controllers are optional devices. Additionally, the memory devices 925 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 910 and/or the RAM 915. Optionally, the program instructions may be stored on a tangible computer readable medium such as a compact disk, a digital disk, flash memory, a memory card, a USB drive, an optical disc storage medium, a distributed computer storage platform such as a cloud-based architecture, and/or other recording medium.

A display interface 930 may permit information from the bus 900 to be displayed on the display 935 in audio, visual, graphic or alphanumeric format. Communication with external devices may occur using various communication ports 940. A communication port 940 may be attached to a communications network, such as the Internet, a local area network or a cellular telephone data network.

The hardware may also include an interface 945 which allows for receipt of data from input devices such as a keyboard 950 or other input device 955 such as a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of assessing a transportation service monitoring system, comprising, by a processor:
accessing a data set comprising a plurality of performance metrics for each of a plurality of route components of a transportation service;
receiving a selected set of operational data parameter labels;
retrieving from the data set, for each of a selected set of route components, the performance metrics that correspond to the labels;
constructing a two-dimensional N×M first matrix P of the performance metrics so that one dimension of the first matrix is a performance metric and each other dimension of the first matrix is a parameter value for a route component with which the performance metric is associated;
determining a distance between each row of the first matrix P and using the distance to construct a second matrix D;
mapping the second matrix D to a coordinate set to yield a third matrix C;
grouping data elements of third matrix C into clusters; and
presenting the clusters on a display so that data elements that are outliers are visually distinguished from data elements that are clustered.

2. The method of claim 1, wherein presenting the clusters on the display also visually identifies clustered data elements that represent redundant information.

3. The method of claim 1, further comprising, by the processor:
before mapping the second matrix D to the third matrix C, detecting which of the outliers are extreme outliers; and
when presenting the clusters on the display, also displaying the extreme outliers so that they are visually distinguished from the clusters and the other outliers.

4. The method of claim 3, wherein detecting the extreme outliers comprises applying robust principal component analysis to the second matrix D or to a function of the second matrix D.

5. The method of claim 4, wherein applying the robust principal component analysis is done to the function of the second matrix D, and the method further comprises generating the function of the second matrix D by:
constructing a matrix J=I_{N×N}−(1, N)*1^{T}*1 where I is the identity matrix, N is the number of rows of first matrix P, and each 1 is a vector containing one row and N columns of ones;
determining D² as a square of every element in second matrix D;
constructing a matrix B=−0.5*J*D²*J; and
using matrix B as the function of D to which the robust principal component analysis is applied.

6. The method of claim 1, further comprising, by the processor before constructing the second matrix D, constructing a transpose M×N matrix P^{T} of matrix P and using the transpose matrix P^{T} in place of first matrix P when determining the distance between each row of the first matrix.

7. The method of claim 1, further comprising, by the processor:
from the data elements of third matrix C, identifying redundant data elements and non-redundant data elements;
constructing a transpose M×N2 matrix P^{T}, where N2 includes none of the redundant data elements;
determining a distance between each row of the transpose matrix P^{T};
using the determined distance between each row of the transpose matrix P^{T} to construct an updated second matrix D₂;
mapping the updated second matrix D₂ to a coordinate set to yield an updated third matrix C₂;
grouping data elements of matrix C₂ into clusters; and
presenting the clusters of matrix C₂ on the display so that data elements that are outliers are visually distinguished from data elements that are clustered.

8. The method of claim 1, wherein presenting the clusters on a display so that outlier data elements are visually distinguished from clustered data elements comprises spatially separating the outlier data elements from the clustered data elements.

9. The method of claim 1, wherein presenting the clusters on a display so that outliers are visually distinguished from clustered data elements comprises, for any data element that is clustered with the group in a displayed two dimensions but an outlier with respect to a third dimension, highlighting the data element in a color that is different from that of the other clustered data elements.

10. A method of assessing transportation service performance, comprising, by a processor:
accessing a data set comprising a plurality of performance metrics for each of a plurality of route components of a transportation service;
receiving a selected set of operational data parameter labels;
retrieving from the data set, for each of a selected set of route components, the performance metrics that correspond to the labels;
constructing a two-dimensional performance metric matrix using the retrieved performance metrics and parameter values;
using values of the two-dimensional performance metric matrix to construct a higher-dimensional matrix;
detecting extreme outliers from data in the higher-dimensional matrix using robust principal component analysis;
mapping the higher-dimensional matrix data to a coordinate matrix;
grouping data elements of the coordinate matrix into clusters; and
presenting the clusters on a display so that data elements that are non-extreme outliers are visually distinguished from data elements that are clustered, and extreme outliers are visually distinguished from both the clustered data elements and the non-extreme outliers.

11. The method of claim 10, wherein presenting the clusters on the display also visually identifies clustered data elements that represent redundant information.

12. The method of claim 10, wherein detecting the extreme outliers comprises applying robust principal component analysis to the second matrix D or to a function of the second matrix D.

13. The method of claim 10, wherein presenting the clusters on a display so that the extreme outliers data elements are visually distinguished from clustered data elements comprises spatially separating the outlier data elements from the clustered data elements.

14. The method of claim 10, wherein presenting the clusters on a display so that outliers are visually distinguished from clustered data elements comprises, for any data element that is clustered with the group in a displayed two dimensions but an outlier with respect to a third dimension, highlighting the data element in a color that is different from that of the other clustered data elements.

15. A transportation service performance assessment system, comprising:
a data set comprising a plurality of performance metrics for each of a plurality of route components of a transportation service;
a display;
a processor; and
a computer-readable medium containing programming instructions that, when executed, instruct the processor to:
receive a selected set of operational data parameter labels,
retrieve from the data set, for each of a selected set of route components, the performance metrics that correspond to the labels,
construct a two-dimensional performance metric matrix using the retrieved performance metrics and parameter values,
use values of the two-dimensional performance metric matrix to construct a higher-dimensional matrix,
detect extreme outliers from data in the higher-dimensional matrix using robust principal component analysis,
map the higher-dimensional matrix data to a coordinate matrix,
group data elements of the coordinate matrix into clusters, and
cause the clusters to be output on the display so that data elements that are non-extreme outliers are visually distinguished from data elements that are clustered, and so that data elements that are extreme outliers are visually distinguished from both the non-extreme outliers and the clustered data elements.

16. The system of claim 15, wherein the instructions that cause the clusters to be output on the display also comprise instructions to visually distinguish clustered data elements that represent redundant information.

17. The system of claim 15, further comprising additional instructions that, when executed, instruct the processor to, before mapping the higher-dimensional matrix to the coordinate matrix, apply robust principal component analysis to the higher-dimensional matrix or to a function of the higher-dimensional matrix.

18. The system of claim 17, wherein the instructions to apply the robust principal component analysis comprise instructions to do so to the function of the higher-dimensional matrix, and the instructions further comprises instructions to generate the function of the higher-dimensional matrix by:
constructing a matrix J=I_{N×N}−(1, N)*1^{T}*1 where I is the identity matrix, N is the number of rows of first matrix P, and each 1 is a vector containing one row and N columns of ones;
determining D² as a square of every element in higher-dimensional matrix;
constructing a matrix B=−0.5*J*D²*J; and
using matrix B as the function of D to which the robust principal component analysis is applied.

19. The system of claim 15, further comprising additional instructions that, when executed, instruct the processor to, before constructing the higher-dimensional matrix, construct a transpose M×N matrix P^{T} of the two-dimensional performance metric matrix and using the transpose matrix P^{T} to determine the distance between each row of the two-dimensional performance metric matrix when constructing the higher-dimensional matrix.

20. The system of claim 15, further comprising additional instructions that, when executed, instruct the processor to, before causing the clusters to be output on the display:
from the data elements of coordinate matrix, identify redundant data elements and non-redundant data elements;
construct a transpose matrix P^{T}, that includes the non-redundant data elements and none of the redundant data elements;
determine a distance between each row of the transpose matrix P^{T};
use the determined distance between each row of the transpose matrix P^{T} to construct an updated higher-dimensional metric;
map the updated higher-dimensional matrix to a coordinate set to yield an updated coordinate matrix;
group data elements of the updated coordinate matrix into clusters; and
when presenting the clusters of on the display, use the clusters from the updated coordinate matrix.

21. The system of claim 15, wherein the instructions to present the clusters on the display so that non-extreme outlier data elements are visually distinguished from clustered data elements comprise instructions to spatially separate the non-extreme outlier data elements from the clustered data elements.

22. The system of claim 15, wherein the instructions to present the clusters on a display so that non-extreme outliers are visually distinguished from clustered data elements comprise instructions to, for any data element that is clustered with the group in a displayed two dimensions but a non-extreme outlier with respect to a third dimension, highlight the data element in a color that is different from that of the other clustered data elements.
